(19) United States
(12) Patent Application Publication
(10) Pub. No.: US 2010/0050523 A1
(43) Pub. Date: Mar. 4, 2010

(54) Safety release mechanism for use with a linear motor turning a ball screw

(76) Inventors: James M. Helms, Fort Myers, FL (US); Jacob S. Schade, Apollo, PA (US); Craig I. Fiedor, Lower Burrell, PA (US)

Correspondence Address: KAREN TANG-WAI SODINI, 216 horseshoe drive, MARS, PA, 16046, US

(21) Appl. No.: 12/462,843

(22) Filed: Aug. 10, 2009

Related U.S. Application Data
(60) Provisional application No. 61/190,135, filed on Aug. 26, 2008.

(51) Int. Cl. E05F 15/10

(52) U.S. Cl. 49/26

(57) ABSTRACT

A safety release mechanism for use with a ball screw type linear motor, featuring a lock lever that can be manually engaged or disengaged. Engaging the lock lever rigidly fixes a telescoping arm, allowing the motor to retract or extend the arm into a cover tube. Disengaging the lock lever allows the telescoping arm to rotate freely in the cover tube. One embodiment of the safety release mechanism is used with a motorized door assist mechanism, however, the release mechanism has many applications beyond a door opener, and can be used in any application requiring a linear motor with a telescoping arm, where in order for the motor to extend or retract the arm, one end of the arm must be fixedly held in place.

### CROSS REFERENCE To RELATED APPLICATIONS

Reference is made to and priority claimed from U.S. provisional application Ser. No. 61/190,135, filed on Aug. 26, 2008.

### FIELD OF THE INVENTION

The present invention pertains to the field of linear motors and door openers. More particularly, the present invention pertains to the field of release mechanisms for linear motors having a telescoping arm, where one end of the arm must be held fixed, usually by attaching to a fixed member, in order for the operational motor to telescope the arm, and the release mechanism provides a simple way to couple the arm to, and decouple the arm from, the fixed member.

### BACKGROUND OF INVENTION

A linear motor using a telescoping arm has many useful applications. A unique feature about one type of linear motor, most commonly a ball screw type linear motor, is that one end of the telescoping arm must be held fixed in place for the motor to extend and retract the arm. Usually, the end is attached to some fixed object or member. If the end is detached from that fixed object or member, or otherwise not held fixed in place, the motor is unable to extend or retract the arm.

One common use for such a motor is with a motorized door opener, where the linear motor assists in the closing and opening of a door. A major issue with a motorized door opener is how to deal with a loss of power so as to allow manual opening and closing of the door. In some cases, the door is relatively lightweight, and manually pulling or pushing on the door will be sufficient, but in the case of military and security force vehicle doors, these doors may weigh as much as 1000 pounds due to armoring, and manually opening the door may be difficult or impossible when the vehicle is positioned on a non-horizontal surface. When the motorized door opener is non-operational, for instance, in the case of an emergency or in the event of power loss, there is neither a fast nor an easy way to disengage the door opener; the opener has to be unbolted in order to manually open or close the door. Obviously, this is neither convenient nor expedient.

Thus, it would be advantageous to have a safety release mechanism for use with a ball screw type linear motor to allow a user to easily and quickly couple or decouple the telescoping arm. In the case of a release mechanism used with a motorized door opener, the safety mechanism would allow a user to easily and conveniently engage or disengage the motor, as preferred, and would allow the user to easily and conveniently open and close a door manually, without the aid of the motor.

### SUMMARY

The invention provides for a safety release mechanism for use with a linear motor having a telescoping arm, the arm attached to a fixed member, enabling a user to couple or decouple the motor's telescoping arm to or from the fixed member.

### BRIEF DESCRIPTION OF THE DRAWINGS

The features and advantages of the invention will become apparent from a consideration of the subsequent detailed description presented in connection with accompanying drawings, in which:

FIG. 1 is a detailed top perspective view of a door opener mounted onto a vehicle body and door, using a linear motor and a ball screw with the safety release mechanism.

FIG. 2 is a detailed perspective view of the safety release mechanism, showing a mechanism bearing housing attached to an end of the actuator and showing a safety release lever in an engaged position.

FIG. 3 is an exploded view of the mechanical bearing housing.

FIG. 4 is a cross sectional view of the mechanical bearing housing and showing the safety release lever in an engaged position.

FIG. 5 is a cross sectional view of the mechanical bearing housing showing moving and stationary portions when the safety release lever is in a disengaged position. Moving portions are represented by hatching.

### DRAWINGS LIST OF REFERENCE NUMERALS

The following is a list of reference labels used in the drawings to label components of different embodiments of the invention, and the names of the indicated components.

80 inner assembly (non rotating)

20 heim joint

20a heim joint coupler assembly

22 end cap screw

22a first end of the coupler assembly

22b second end of the coupler assembly

23 outer or exterior assembly

24 housing

24a housing center-interface gap where the actuator attachment and the coupler assembly meet

24b proximal end of the housing

24c distal end of the housing

26 actuator attachment

28 mechanism bearings

30 safety release mechanism

31 mechanism dust cap

32 safety release lever

33 washers

34 manual release (cable system)

36 notches in the safety release mechanical housing

37 end cap

50 lever arm

52a motor first end

52c cover tube

52d telescoping arm

60 linear motor

100a door opener

102 vehicle body

106 door

### DETAILED DESCRIPTION

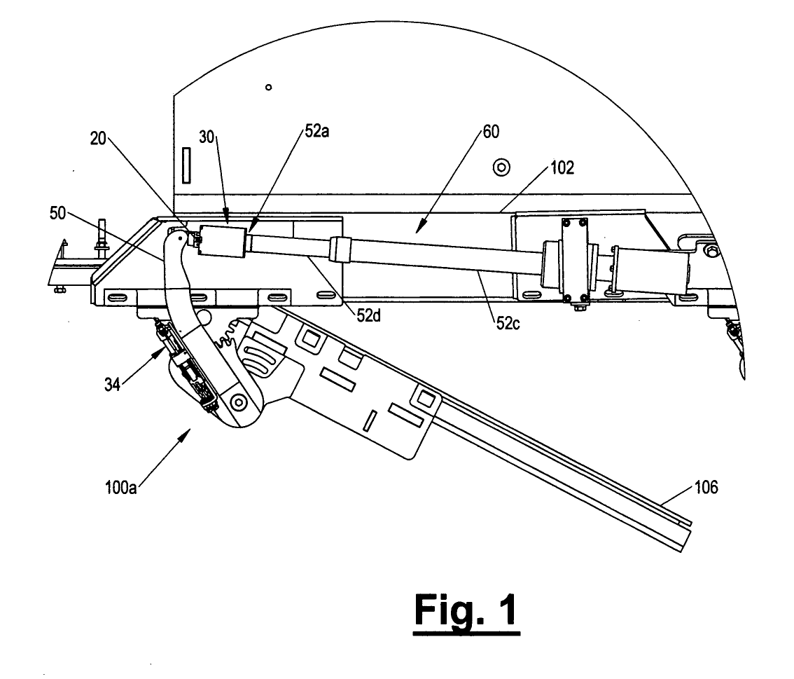

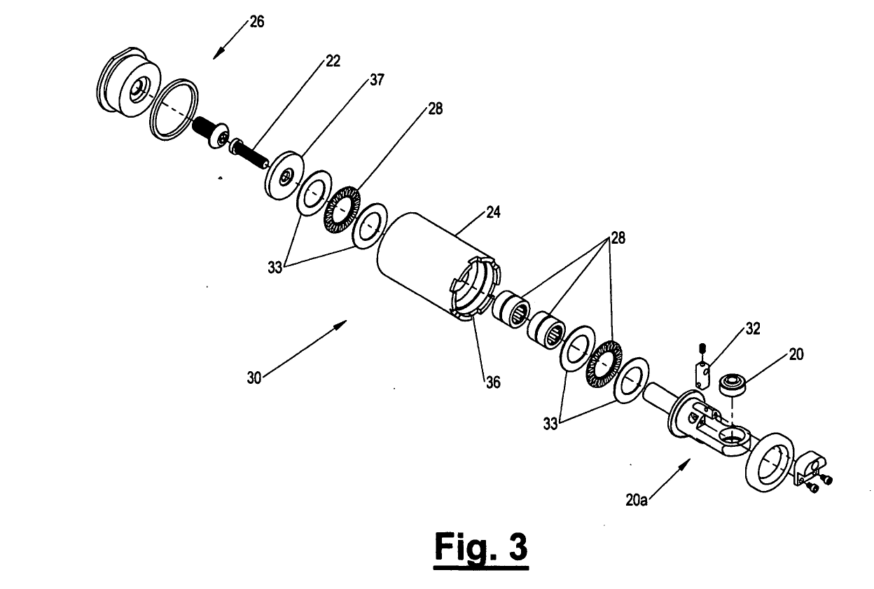

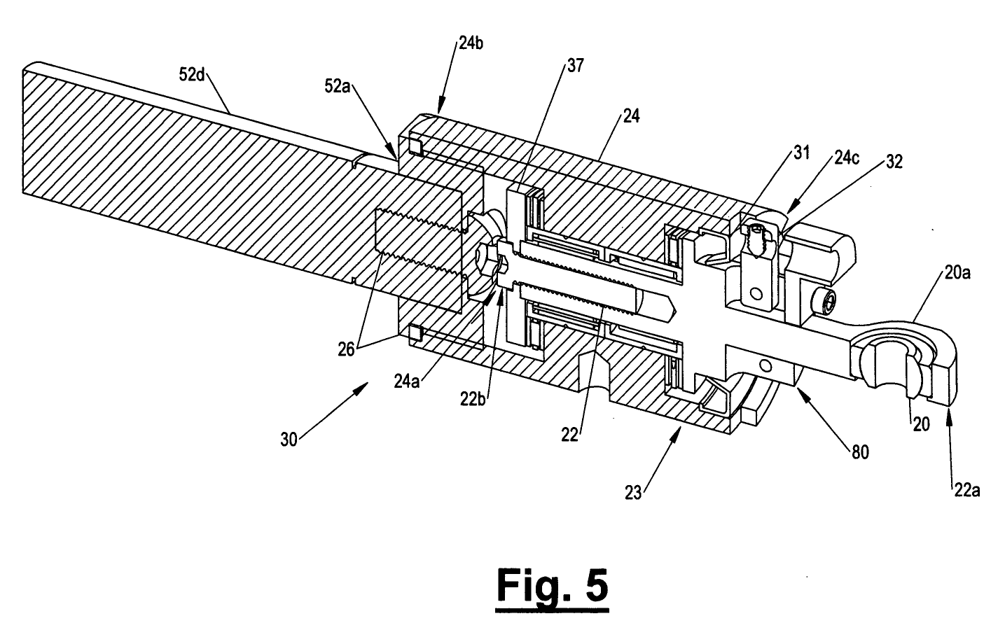

Referring to FIGS. 1-5, a safety release mechanism 30 according to the invention comprises two main components: an interior assembly 80 and an exterior assembly 23 (FIG. 5). When the mechanism is engaged, both the interior and exterior assemblies remain in a fixed position; when the mechanism is disengaged, the interior assembly remains in a fixed position while the exterior assembly rotates freely relative to the interior assembly, as shown more particularly in FIG. 5, in which rotating parts are represented by hatching.

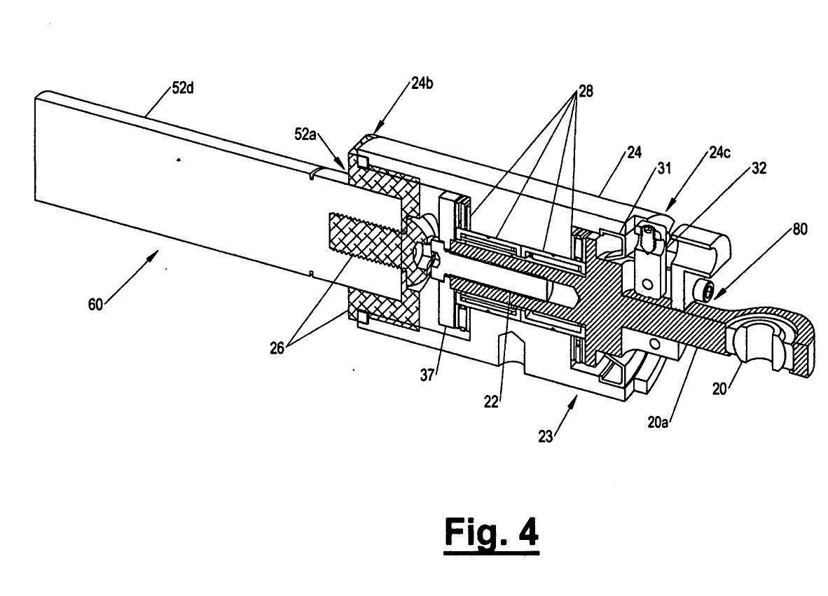

Referring more particularly to FIGS. 4 and 5, the interior assembly 80 comprises a heim joint 20 nestled inside a first end 22a of a heim joint coupler assembly 20a, and an end cap 37 screwably attached to a second end 22b of the coupler assembly 20a by an end cap screw 22. The interior assembly 80 is disengagably coupled at the heim joint 20 to a fixed member 50 (shown in FIG. 1). A safety release lever 32 attached to the coupler assembly 20a is located at a distal end 24c of a housing 24.

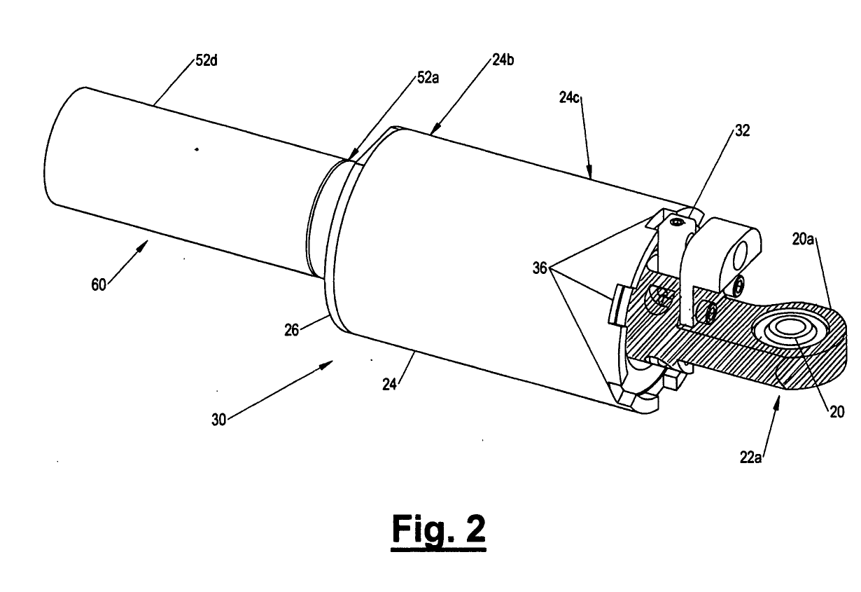

Referring more particularly to FIGS. 4 and 5, the exterior assembly 23 comprises the housing 24 screwably attached to an actuator attachment 26 at a housing proximal end 24b. At least one notch 36 is cut into the distal end 24c of the housing 24 (FIG. 2). Mechanical bearings 28 surround the coupler assembly 20a inside the housing 24 (FIG. 4).

Referring to FIGS. 1 and 2, to use the mechanism 30, a linear motor 60, comprising a cover tube 52c with an internal ball screw (not shown) and a telescoping arm 52d, is screwably attached at motor first end 52a to the actuator attachment 26 at the housing proximal end 24b. The motor telescopes the arm in and out of the cover tube 52c, depending on the direction the motor is operated, and the telescoping arm 52d can only be extended or retracted by the motor when the arm 52d is held fixed at the first end 52a. In the embodiment shown in FIG. 1, the arm 52d is held fixed at the heim joint 20 coupled to a lever arm 50 of a door opener 100a when the mechanism 30 is engaged.

To engage the safety release mechanism 30, the safety release lever 32 is positioned inside a notch 36 cut into the distal end 24c of the housing 24, locking the exterior assembly 23 and the interior assembly 80 together (FIG. 4), and with it, the telescoping arm 52d. The operational motor 60 can thus extend or retract the arm 52d, depending on the direction the motor is operated, causing a door 106 attached to the lever arm 50 to open or close. When the lever is disengaged, the lever fails to engage a notch, resulting in the exterior assembly 23 and the telescoping arm 52d rotating freely, as shown in FIG. 5, represented by hatching in the drawing. At a housing center 24a there is a gap that is the interface point of the rotatable exterior assembly 23 and the stationary interior assembly 80. Although the internal assembly 80 remains stationary regardless of the position of the lever, disengaging the lever nevertheless effectively decouples the heim joint 20 from the lever arm 50, thus rendering the motor incapable of telescoping the arm 52d. Referring to FIG. 1, when the lever 32 is disengaged, the door 106 can nevertheless be opened, because the freely exterior assembly 23 and arm 52d can now be manually pulled or pushed to telescope in and out of the cover tube 52c.

One embodiment of the invention, shown in FIG. 1, provides a manual release 34, generally comprising a cable pull switch system attached to the release lever 32, allowing the mechanism 30 to be engaged or disengaged from inside or outside a vehicle 102.

The invention is described in FIGS. 1-5 in terms of an embodiment used in conjunction with the motorized door opener 100a for opening armored doors of a HMMWV (High Mobility Multipurpose Wheeled Vehicle). It should be understood, however, that the invention has a more general applicability as it can be used with any linear motor requiring the telescoping end to be held fixed in order to operate, such as is the case of a linear motor turning an internal ball screw as a basis for extending or retracting a telescoping arm.

The safety release mechanism 30 and door opener shown more particularly in FIG. 1 are both made by Ibis Tek, LLC, of Butler, Pa. (no part numbers available yet). The motor 60 including the telescoping arm and cover tube as shown particularly in FIG. 1 are available as a single unit from Motion Systems Corporation of Eatontown, N.J., part number 85261.

Thus, the invention provides a safety release mechanism of use in case of a linear motor for pushing or pulling on the lever arm. An embodiment of the invention is described herein as a component of a motorized door opener, however, the safety release mechanism is of use in any application of a linear motor telescoping an arm and requiring one end of the arm to be held fixed during operation of the motor.

It is to be understood that the arrangements shown and described above and in the attachments are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A safety release mechanism (30) for use with a linear motor (60) having a telescoping arm (52d) extending into and retracting out of a cover tube (52c), the telescoping arm being fixedly held at a first end (52a) of the motor to a fixed member (50) when the motor is operational, the safety release mechanism comprising:
a non-rotatable interior assembly (80) comprising a Heim joint coupler assembly (20a) having a first end (22a) and a second end (22b), a Heim joint (20) nestled inside an opening in the first end (22a) and an end cap (37) screwably attached by an end cap screw (22) to the coupler assembly second end (22b);
a rotatable exterior assembly (23) comprising a housing (24) having a proximal end (24b) and a distal end (24c), the assembly (23) screwably attached at the proximal end to the telescoping arm (52d) at the motor first end (52a) by an actuator attachment (26);
a plurality of mechanism bearings (28) disposed inside the housing (24) and surrounding the coupler assembly (20a); and
a release lever (32) attached to the Heim joint coupler assembly (20a) at the housing distal end (24c);
wherein the exterior and interior assemblies meet at a center gap (24a) defining an interface within the mechanism (30) between the rotatable and non-rotatable assemblies; and
wherein the housing (24) further comprises at least one notch (36) at the distal end (24c) of the housing (24);
whereby the lever (32) engaging the at least one notch (36) locks the exterior and interior assemblies together, coupling the Heim joint (20) to the fixed member (50) and allowing the motor to extend and retract the telescoping arm (52d) out of and into the cover tube (52c), and disengaging the lever from the at least one notch decouples the Heim joint (20) from the fixed member (50) by allowing the exterior assembly (23) and telescoping arm (52d) to freely extend into or retract out of the cover tube (52c) without the aid of the motor.

2. The safety release mechanism (30) of claim 1, further comprising at least one cable pull (34) for mechanically engaging or disengaging the lever (32).

3. The safety release mechanism (30) of claim 1, wherein the mechanism (30) is a component of a door assist mechanism (100a).

4. The safety release mechanism (30) of claim 1, wherein the linear motor (60) extends or retracts the telescoping arm (52d) by turning a ball screw.
